(19) United States
(12) Patent Application Publication
(10) Pub. No.: US 2008/0186302 A1
(43) Pub. Date: Aug. 7, 2008

(54) DISPLAY WITH CHARGE FUNCTION AND DISPLAY CONTROLLER THEREOF

(75) Inventor: Rei-Hong Chang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: NOVATEK MICROELECTRONICS CORP., Hsinchu (TW)

(21) Appl. No.: 11/622,472

(22) Filed: Jan. 12, 2007

(30) Foreign Application Priority Data
Dec. 6, 2006 (TW) 095145353

(51) Int. Cl. G09G 5/00; G05F 1/10; H02J 7/00

(52) U.S. Cl. 345/212; 323/282; 320/114

(57) ABSTRACT

A display with charge function and a display controller thereof are provided. The display provided by the present invention includes a display controller and a charge base, wherein the display controller is built-in in the display, and includes a voltage output unit and a voltage detecting/regulating unit. The voltage output unit is used to provide an output voltage according to a pulse width modulation (PWM) signal. The voltage detecting/regulating unit is used to detect the output voltage output by the voltage output unit, and generate a regulating signal accordingly to regulate the pulse width of the PWM signal. The charge base is disposed on the display for charging a storage device on the charge base according to the output voltage output by the voltage output unit, wherein the voltage value of the output voltage output by the voltage output unit is followed by the pulse width of the PWM signal.

### CROSS-REFERENCE TO RELATED APPLICATION

This application claims the priority benefit of Taiwan application serial no. 95145353, filed Dec. 6, 2006. All disclosure of the Taiwan application is incorporated herein by reference.

### BACKGROUND OF THE INVENTION

1. Field of the Invention

The present invention relates to a display with charge function. More particularly, the present invention relates to a display with charge function and a display controller thereof.

2. Description of Related Art

The rapid development of multimedia society mostly benefits from the tremendous progress in semiconductor devices or display apparatus. As for displays, thin film transistor liquid crystal displays (TFT-LCDs) with high definition, preferred space utilization, low power consumption, and no radiation have gradually become the mainstream of the market.

To follow the trend of this era, a part of the designers of TFT-LCD have additionally disposed universal serial bus HUB (USB HUB) onto the TFT-LCD, such that a user can employ USB HUB to charge rechargeable batteries of some handheld electronic devices (i.e., the handheld electronic devices requiring for an electric power of approximately 5V). Such a convenient design idea has indeed improved the competitiveness of the TFT-LCD.

However, the USB HUB additionally disposed on the TFT-LCD only provides an electric power of about 5V to charge the rechargeable batteries of the handheld electronic devices, without involving any mechanism relevant to charge protection. Therefore, the situation that the USB HUB still keeps charging the rechargeable batteries of the handheld electronic devices when the batteries have already been fully charged tends to occur, which may well results in the aging or damage of the rechargeable batteries of the handheld electronic devices.

Moreover, as the existing handheld electronic devices have various types and the specifications of the rechargeable batteries of the handheld electronic devices are different, the USB HUB cannot fully conform to the specifications of the rechargeable batteries of all existing handheld electronic devices, and thus, exclusive charges must be made for the handheld electronic devices not in conformity to the charge specification of the USB HUB to charge the rechargeable batteries thereof. It can be known that, each manufacturer respectively fabricates exclusive charges for handheld electronic devices of their own, and the fabrication of excessive charges is a waste of the natural resource of the earth.

### SUMMARY OF THE INVENTION

Accordingly, the present invention is directed to provide a display controller, which provides an output voltage according to a pulse width modulation (PWM) signal, and detects the output voltage at any time to regulate the pulse width of the PWM signal in real-time, such that the output voltage thereof is output stably.

The present invention is also directed to provide a display with charge function, which charges a rechargeable battery of a handheld electronic device by using the display controller of the present invention disposed therein.

As embodied and broadly described herein, the display controller provided by the present invention is built-in in a display, and comprises a voltage output unit and a voltage detecting/regulating unit. The voltage output unit is used to provide the output voltage according to the PWM signal. The voltage detecting/regulating unit is used to detect the output voltage provided by the voltage output unit, and generate a regulating signal accordingly to regulate the pulse width of the PWM signal. The voltage value of the output voltage provided by the voltage output unit is followed by the pulse width of the PWM signal.

From another point of view, the display with charge function provided by the present invention comprises a display controller and a charge base. The display controller is built-in in the display, and comprises a voltage output unit and a voltage detecting/regulating unit. The voltage output unit is used to provide the output voltage according to the PWM signal. The voltage detecting/regulating unit is used to detect the output voltage provided by the voltage output unit, and generate a regulating signal accordingly to regulate the pulse width of the PWM signal. The charge base is disposed on the display, and is used to charge a storage device on the charge base according to the output voltage provided by the voltage output unit, wherein the voltage value of the output voltage provided by the voltage output unit is followed by the pulse width of the PWM signal.

In a preferred embodiment of the present invention, the pulse width of the PWM signal is determined by an on screen display (OSD) menu of the display.

In the display with charge function provided by the present invention, with the display controller provided by the present invention disposed therein, a user can change the pulse width of the PWM signal only by selecting the output voltage to be provided through the OSD menu of the display, and thus the display with charge function provided by the present invention can regulate the electric power of the charge base additionally disposed therein according to the specification of the rechargeable battery of the handheld electronic device to be charged. Therefore, it is unnecessary to fabricate an exclusive charger for the handheld electronic device, thereby saving the natural resource of the earth. In addition, the display with charge function provided by the present invention further uses the voltage detecting/regulating unit of the display controller as a charge protection mechanism, so as to avoid the aging or damage of the rechargeable battery of the handheld electronic device.

In order to make the aforementioned and other objectives, features, and advantages of the present invention comprehensible, preferred embodiments accompanied with figures are described in detail below.

### BRIEF DESCRIPTION OF THE DRAWINGS

FIG. 1 is a schematic view of the display with charge function according to a preferred embodiment of the present invention.

FIG. 2 is a schematic view of the charge base according to a preferred embodiment of the present invention.

FIG. 3 is a block diagram of the display with charge function according to a preferred embodiment of the present invention.

FIG. 4 is a circuit diagram of the voltage output unit according to a preferred embodiment of the present invention.

### DESCRIPTION OF EMBODIMENTS

The technical efficacy to be achieved by the present invention is additionally disposing a charge base on a display, and selecting the power of the charge base on an OSD menu according to the specification of the rechargeable batteries of existing handheld electronic devices. The following content is directed to provide a detailed description of the technical features and efficacy to be achieved by the present invention, thus providing a detailed reference for those relevant to the art of the present invention.

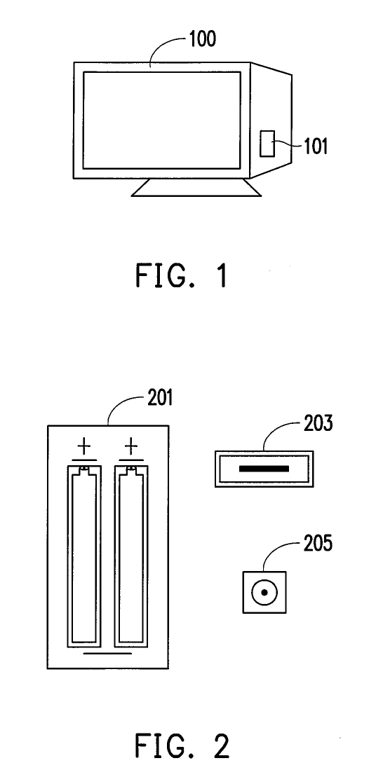

FIG. 1 is a schematic view of a display 100 with charge function according to a preferred embodiment of the present invention. Referring to FIG. 1, the display 100 is a common thin film transistor liquid crystal display (TFT-LCD), which has a charge base 101 additionally disposed on the right side thereof for charging the rechargeable battery of an existing handheld electronic device (not shown).

FIG. 2 is a schematic view of a charge base 101 according to this embodiment. Referring to FIG. 1 and FIG. 2 together, in this embodiment, the charge base 101 is, for example, an AA/AAA charger 201, an USB type A connector 203, or a DC power jack 205, but not limited herein. That is to say, the designer can additionally dispose different charge bases on the display 100 according to practical requirements.

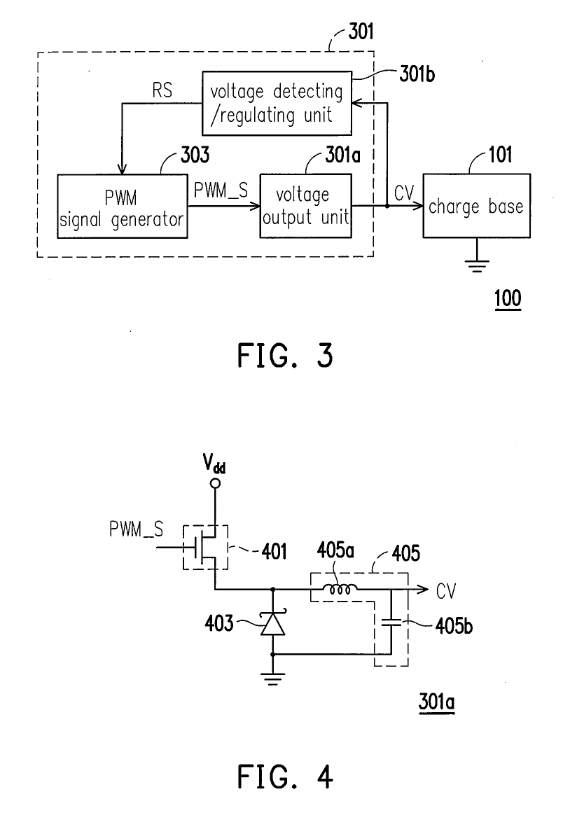

FIG. 3 is a block diagram of the display with charge function 100 according to this embodiment. Referring to FIG. 1-FIG. 3, the display 100 includes a display controller 301 and a charge base 101. The display controller 301 serves as the core of the operation of the whole display 100, which is well known by those of ordinary skill in the art, and thus, only the portion required by the present invention is illustrated in detail while other functions of the display controller 301 are not described herein again for avoiding confusing the spirit of the present invention.

In this embodiment, the display controller 301 includes a voltage output unit 301a and a voltage detecting/regulating unit 301b. The voltage output unit 301a is used to provide an output voltage CV to the charge base 101 according to a PWM signal PWM_S output by a PWM signal generator 303. The voltage detecting/regulating unit 301b is used to detect the output voltage CV, and generate a regulating signal RS accordingly to regulate the pulse width of the PWM signal PWM_S output by the PWM signal generator 303, wherein the pulse width of the PWM signal PWM_S output by the PWM signal generator 303 is determined by the OSD menu of the display 100, and the voltage value of the output voltage CV provided by the voltage output unit 301a is followed by the pulse width of the PWM signal PWM_S.

The charge base 101 is coupled between the display controller 301 and a common potential (e.g., ground potential), and the charge base 101 charges a storage device (not shown) on the charge base 101 according to the output voltage CV provided by the voltage output unit 301a, wherein the storage device is, for example, a rechargeable battery of a handheld electronic device.

FIG. 4 is a circuit diagram of the voltage output unit 301a according to this embodiment. Referring to FIG. 3 and FIG. 4 together, the voltage output unit 301a includes a switching switch 401, a rectifying element 403 and a low pass filter 405. Whether the switching switch 401 is turned on or not is determined according to the PWM signal PWM_S output by the PWM signal generator 303. A cathode of the rectifying element 403 is coupled to the switching switch 401, an anode thereof is coupled to the common potential (i.e., the ground potential), and the function of the rectifying element (e.g., a Schottky rectifying diode IN5824) 403 is limiting the flowing direction of the current. The low pass filter 405 and the rectifying element 403 are connected in parallel for providing the output voltage CV.

In this embodiment, the switching switch 401 is implemented as a power MOS, which has a drain for receiving a system voltage Vdd (e.g., 12 V), a gate for receiving the PWM signal PWM_S output by the PWM signal generator 303, and a source coupled to the cathode of the rectifying element 403. The low pass filter 405 includes an inductor 405a and a capacitor 405b. A first end of the inductor 405a is coupled to the cathode of the rectifying element 403, a second end of the inductor 405a is coupled to a positive end of the capacitor 405b, for providing the output voltage CV to the charge base 101, and a negative end of the capacitor 405b is coupled to the common potential (i.e., the ground potential).

It should be noted that, from the circuit diagram of the voltage output unit 301a disclosed in FIG. 4, it can be seen by those of ordinary skill in the art that it is a buck circuit, and the circuit principle thereof will not be described herein again.

Accordingly, when the user operates the OSD menu of the display 100 and determines to select the output voltage CV of, for example, 1.5 V, the pulse width of the PWM signal PWM_S output by the PWM signal generator 303 in the display controller 301 also changes, such that the output voltage CV provided by the low pass filter 405 is 1.5 V, thereby charging the storage device on the charge base 101.

It should be noted that, when the power on the charge base 101 exceeds the original voltage value (i.e., 1.5 V) set by the user, the voltage detecting/regulating unit 301b generates a regulating signal RS correspondingly, so as to regulate the pulse width of the PWM signal PWM_S output by the PWM signal generator 303, such that the low pass filter 405 can output the output voltage CV to the charge base 101 more stably.

Accordingly, in brief, when the power on the charge base 101 exceeds 1.5 V, the pulse width of the PWM signal PWM_S output by the PWM signal generator 303 is narrowed; while when the power on the charge base 101 is below 1.5 V, the pulse width of the PWM signal PWM_S output by the PWM signal generator 303 is broadened, and therefore, the output voltage CV provided by the low pass filter 405 maintains at 1.5 V set by the user.

In addition, the user can select a suitable output voltage CV for the charge base 101 on the OSD menu of the display 100 according to the specification of the rechargeable battery of the used handheld electronic device, and the operation principle thereof is similar to that of the above description, which will not be described herein again.

In view of the above, the present invention provides a display with charge function and a display controller thereof. According to the spirit of the present invention, the following advantages are available.

1. In the display with charge function provided by the present invention, the display controller provided by the present invention is disposed, such that the user can change the pulse width of the PWM signal only by selecting the output voltage to be provided through an OSD menu of the display, and thus the display with charge function provided by the present invention can regulate the power of the charge base additionally disposed according to the specification of the rechargeable battery of the handheld electronic device to be charged. Therefore, it is unnecessary to fabricate an exclusive charger for the handheld electronic device, thereby saving the natural resource of the earth.

2. The display with charge function provided by the present invention further uses the voltage detecting/regulating unit of the display controller as a charge protection mechanism, so as to avoid the aging or damage of the rechargeable battery of the handheld electronic device.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A display controller, built-in in a display, comprising:
a voltage output unit, for providing an output voltage according to a pulse width modulation (PWM) signal; and
a voltage detecting/regulating unit, coupled to the voltage output unit, for detecting the output voltage and generating a regulating signal accordingly to regulate a pulse width of the PWM signal,
wherein the voltage value of the output voltage is followed by the pulse width of the PWM signal.

2. The display controller as claimed in claim 1, wherein the voltage output unit comprises:
a switching switch, to be turned on or not according to the PWM signal;
a rectifying element, having a cathode coupled to the switching control unit, and an anode coupled to a common potential, wherein the rectifying element is used for limiting the flowing direction of the current; and
a low pass filter, connected to the rectifying element in parallel, for providing the output voltage.

3. The display controller as claimed in claim 2, wherein the switching switch comprises a power MOS, having a first drain/source for receiving a system voltage, a gate for receiving the PWM signal, and a second drain/source coupled to the cathode of the rectifying element.

4. The display controller as claimed in claim 3, wherein the low pass filter comprises:
an inductor, having a first end coupled to the cathode of the rectifying element, and a second end for providing the output voltage; and
a capacitor, having a positive end coupled to the second end of the inductor, and a negative end coupled to the common potential.

5. The display controller as claimed in claim 2, wherein the rectifying element comprises a Schottky rectifying diode.

6. The display controller as claimed in claim 1, wherein the display comprises a thin film transistor liquid crystal display (TFT-LCD).

7. The display controller as claimed in claim 1, wherein the pulse width of the PWM signal is determined by an on screen display (OSD) menu of the display.

8. A display with charge function, comprising:
a display controller, built-in in the display, comprising:
a voltage output unit, for providing an output voltage according to a PWM signal; and
a voltage detecting/regulating unit, coupled to the voltage output unit, for detecting the output voltage and generating a regulating signal accordingly to regulate a pulse width of the PWM signal; and
a charge base, disposed on the display, and coupled between the display controller and a common potential, for charging a storage device on the charge base according to the output voltage,
wherein the voltage value of the output voltage is followed by the pulse width of the PWM signal.

9. The display with charge function as claimed in claim 8, wherein the voltage output unit comprises:
a switching switch, to be turned on or not according to the PWM signal;
a rectifying element, having a cathode coupled to the switching control unit, and an anode coupled to a common potential, wherein the rectifying element is used for limiting the flowing direction of the current; and
a low pass filter, connected to the rectifying element in parallel, for providing the output voltage.

10. The display with charge function as claimed in claim 9, wherein the switching switch comprises a power MOS, having a first drain/source for receiving a system voltage, a gate for receiving the PWM signal, and a second drain/source coupled to the cathode of the rectifying element.

11. The display with charge function as claimed in claim 10, wherein the low pass filter comprises:
an inductor, having a first end coupled to the cathode of the rectifying element, and a second end for providing the output voltage; and
a capacitor, having a positive end coupled to the second end of the inductor, and a negative end coupled to the common potential.

12. The display with charge function as claimed in claim 9, wherein the rectifying element comprises a Schottky rectifying diode.

13. The display with charge function as claimed in claim 8, wherein the specification of the charge base comprises an AA/AAA charger, a DC power jack, or a USB type A connector.

14. The display with charge function as claimed in claim 8, wherein the storage device comprises a rechargeable battery.

15. The display with charge function as claimed in claim 8, wherein the display comprises a TFT-LCD.

16. The display with charge function as claimed in claim 8, wherein the pulse width of the PWM signal is determined by an OSD menu of the display.
